(19) United States
(12) Patent Application Publication
(10) Pub. No.: US 2015/0004810 A1
(43) Pub. Date: Jan. 1, 2015

(54) ALL-IN-ONE COMPUTER WITH FIXED AND SIMPLE CONNECTION

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: YONG-JUN SONG, Wuhan (CN); YONG-ZHAO HUANG, Wuhan (CN); YI-HUNG PENG, New Taipei (TW)

(21) Appl. No.: 14/314,672

(22) Filed: Jun. 25, 2014

(30) Foreign Application Priority Data
Jun. 27, 2013 (CN) 2013102621473

(51) Int. Cl. H01R 12/70

(52) U.S. Cl. CPC H01R 12/70
USPC 439/65

(57) ABSTRACT

An all-in-one (AIO) computer with a fixed and simple connection includes a panel, a motherboard, and a connector. The connector includes a male connector and a female connector. The male connector is mounted on the motherboard and the female connector is mounted on the panel. The panel communicates with the motherboard through the connector.

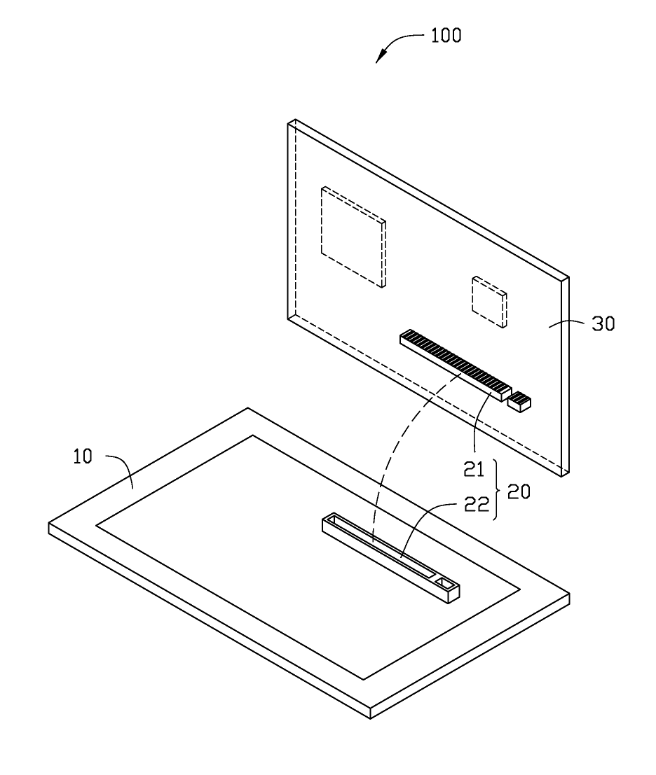

### FIELD

The subject matter herein generally relates to computer data channels.

### BACKGROUND

A flexible printed circuit (FPC) provides an unreliable connection between a panel interface and a motherboard of an all-in-one (AIO) computer.

### BRIEF DESCRIPTION OF THE DRAWING

Implementations of the present technology will now be described, by way of example only, with reference to the attached FIGURE:

The drawing is an isometric exploded view of an embodiment of an AIO computer with a simple and fixed connection.

### DETAILED DESCRIPTION

It will be appreciated that for simplicity and clarity of illustration, where appropriate, reference numerals have been repeated among the different FIGURES to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

The present disclosure is described in relation to an all-in-one (AIO) computer 100 with an internal connection.

The FIGURE illustrates an embodiment of an AIO computer 100. In at least one embodiment, the AIO computer 100 can comprise a panel 10, a motherboard 30, and a connector 20. The connector 20 can comprise a male connector 21 and a female connector 22. The male connector 21 can be inserted into the female connector 22 to ensure a permanent physical and electronic connection between the two.

A plurality of electronic elements, such as central processing unit (CPU), is mounted on a first side of the motherboard 30. The male connector 21 is mounted on a second side of the motherboard 30. The female connector 22 is mounted on a back of the panel 10.

In assembly, the male connector 21 on the motherboard 30 is inserted into the female connector 22 on the panel 10. Therefore the panel 10 can electrically communicate with the motherboard 30 through the connector 20. The male connector 21 of the motherboard 30 transfers signals, such as data signals, clock signals, and or control signals, to the female connector 22. The panel 10 receives the signals from the female connector 22. The panel 10 transfers signals, such as touch signals, to the motherboard 30 through the female connector 22 and the male connector 21.

In another embodiment, the male connector 21 can be mounted on the panel 10, and the female connector 22 can be mounted on the motherboard 30.

The connector 20 replaces the flexible printed circuit (FPC) between the panel 10 and the motherboard 30 in the AIO computer 100 for high reliability.

The embodiment shown and described above is only an example. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An all-in-one (AIO) computer with fixed and simple connection, the AIO computer comprising:
a panel;
a motherboard; and
a connector comprising:
a male connector mounted on the motherboard; and
a female connector mounted on the panel and configured to receive the male connector;
wherein the panel is configured to communicate with the motherboard through the connector when the male connector and female connector are matingly joined.

2. The AIO computer of claim 1, wherein the motherboard transfers data signals, clock signals, and/or control signals to the panel through the male connector and the female connector.

3. The AIO computer of claim 1, wherein the panel transfers touch signals to the motherboard through the female connector and the male connector.

4. An all-in-one (AIO) computer with a fixed and simple connection, the AIO computer comprising:
a panel;
a motherboard; and
a connector comprising:
a male connector mounted on the panel; and
a female connector mounted on the motherboard and configured to receive the male connector;
wherein the panel is configured to communicate with the motherboard through the connector when the male connector and female connector are matingly joined.

5. The AIO computer of claim 4, wherein the motherboard transfers data signals, clock signals, and/or control signals to the panel through the female connector and the male connector.

6. The AIO computer of claim 4, wherein the panel transfers touch signals to the motherboard through the male connector and the female connector.
